(19) United States
(12) Patent Application Publication
(10) Pub. No.: US 2014/0377470 A1
(43) Pub. Date: Dec. 25, 2014

(54) CUTTING-IN, STANDOFF, ILLUMINATION SYSTEM AND METHOD

(71) Applicant: John D. Bailey, Richfield, UT (US)

(72) Inventor: John D. Bailey, Richfield, UT (US)

(21) Appl. No.: 14/185,654

(22) Filed: Feb. 20, 2014

Related U.S. Application Data
(60) Provisional application No. 61/838,930, filed on Jun. 25, 2013.

(51) Int. Cl. A46B 15/00; A46B 3/12; B05D 1/28; B44D 3/00

(52) U.S. Cl. CPC A46B 15/0036; B44D 3/00; A46B 3/12; B05D 1/28
USPC 427/429; 15/105; 29/428; 29/525.01

(57) ABSTRACT

An apparatus and method provide an adjustable, aimed, lighting system that may be selectively secured to and removed from the ferrule of a paintbrush for illuminating the edge of the bristles during a cutting-in process. The light may be moved as appropriate, and may be aimed to ride with the brush, thus illuminating directly at the edge where paint is being deposited. Thus, precise deposition of paint may be done in spite of the shadows cast by the body of the painter and the bulk of the brush during much of such cutting-in procedures.

### RELATED APPLICATIONS

This application claims the benefit of U.S. Provisional Patent Application Ser. No. 61/838,930, filed Jun. 25, 2013, which is hereby incorporated by reference in its entirety.

### BACKGROUND

1. Field of the Invention

This invention relates to painting and, more particularly, to novel systems and methods for lighting a work area for a paintbrush during a cutting-in operation.

2. Background Art

For residential and commercial painting of interior surfaces, boundaries are the most difficult and time consuming. For example, a window may have a stained wood color, as to the seal and frame, while the surrounding wall is painted a particular color of the room. Although masking is possible, many commercial painters will simply “cut-in” along a boundary line, such as an internal corner, external corner, boundary line, or the like.

Cutting-in is the process of pressing the bristles of a paintbrush sideways flat against a surface being painted, while bending the handle toward a more perpendicular position with respect to the wall, thus spreading out the bristles to form a very thin edge at the far extreme. By drawing the brush with that line along the boundary, one may precisely position a difference in paint color while drawing the brush and depositing paint.

Cutting-in may be used around frames of doors, frames of windows, crown moldings, baseboards, internal corners, fixtures and attachments in walls, HVAC inlets and outlets, and the like. Thus, in a room, a significant number of regions may exist that require cutting-in by a painter.

Unfortunately, light is a perennial problem. Even in daylight, or room lighting system light, and even with specialized flood lighting set up by a painter, light is a problem. The specific problem is that a painter is close to a brush, the brush is against the wall, and everything culminates at the wall on the edge of the brush as painting continues. However, all light is typically on the opposite side of the painter from the brush.

Even with excellent illumination, the speed, change of position, and so forth render a shadow in the area of a brush repeatedly. Thus, even if the light is excellent at one moment, a few moments later shadows may intervene. Shadows inhibit an ability to see clearly changes in color and the exact location of paint deposits. Moreover, bright working lights result in reflections from a wall, which tend to close down the pupils of a painter. Accordingly, having adjusted to increased ambient light, the eyes can no longer properly distinguish the fine distinctions in the shadowed region near the tip of the brush.

What is needed is a localized illumination system and method for a paintbrush during close operations, where sight, color, and precision are required.

### BRIEF SUMMARY OF THE INVENTION

In view of the foregoing, in accordance with the invention as embodied and broadly described herein, a method and apparatus are disclosed in one embodiment of the present invention as including a securement mechanism, a standoff, and a light assembly that secured to a ferrule of a brush, or nearby, such as on a ferrule, in order to readily aim light and illuminate the edge of a paintbrush during cutting-in processes.

In certain embodiments, the securement mechanism may be selected from hook-and-loop fasteners, a ball and socket type of snap, any other type of snap, various shapes, sizes, and thicknesses of magnets, simple doubly adhesive spacer materials, or a spacing material containing adhesive on of at least two sides, or the like may act like a securement. Meanwhile, the size, or an additional spacer may be selected in order to stand a light assembly some distance off the ferrule of the brush and thereby provide a central axis of light that is offset from an outer surface of the brush in its undisturbed state.

For example, when the bristles of a brush are bent and drawn to a thin edge, the heel of the brush and handle necessarily aim at a location different from that edge. Accordingly, a standoff permits the light to be centered, or in least include or illuminate the edge where precision and good eyesight is best assisted by the additional illumination.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a perspective view of one embodiment of a system for implementing an apparatus and method in accordance with the invention, including a brush, with the bristles in an undisturbed orientation, and a lighting assembly secured at a specific standoff distance to the ferrule;

FIG. 2 is a perspective view of the system of FIG. 1, illustrating alternative embodiments of particular components, such as the lighting assembly housing, the standoff, securement mechanisms, batteries, and so forth;

FIG. 3 is a perspective view of the brush of FIGS. 1 and 2 with a lighting assembly in one embodiment, illustrating the bristles deformed into the fine edge required for cutting-in, and that edge illuminated by a lighting system in accordance with the invention;

FIG. 4 is a schematic block diagram of one embodiment of a process and method for implementing an apparatus as illustrated in FIGS. 1 through 3;

FIG. 5A is a frontal perspective view of an alternative embodiment to the apparatus of FIGS. 1 through 3;

FIG. 5B is a rear perspective view thereof;

FIG. 5C is a top plan view thereof;

FIG. 5D is a bottom plan view thereof;

FIG. 5E is a front elevation view thereof;

FIG. 5F is a rear elevation view thereof;

FIG. 5G is a left side elevation view thereof;

FIG. 5H is a right side elevation view thereof;

FIG. 6A is a frontal perspective view of an alternative embodiment of a painting light system in accordance with the invention;

FIG. 6B is a rear perspective view thereof;

FIG. 6C is a top plan view thereof;

FIG. 6D is a bottom plan view thereof;

FIG. 6E is a front elevation view thereof;

FIG. 6F is a rear elevation view thereof;

FIG. 6G is a left side elevation view thereof;

FIG. 6H is a right side elevation view thereof;

FIG. 7A is a frontal perspective view of an alternative embodiment of a painting light in accordance with the invention;

FIG. 7B is a rear perspective view thereof;

FIG. 7C is a top plan view thereof;

FIG. 7D is a bottom plan view thereof;

FIG. 7E is a front elevation view thereof;

FIG. 7F is a rear elevation view thereof;

FIG. 7G is a left side elevation view thereof; and

FIG. 7H is a right side elevation view thereof.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

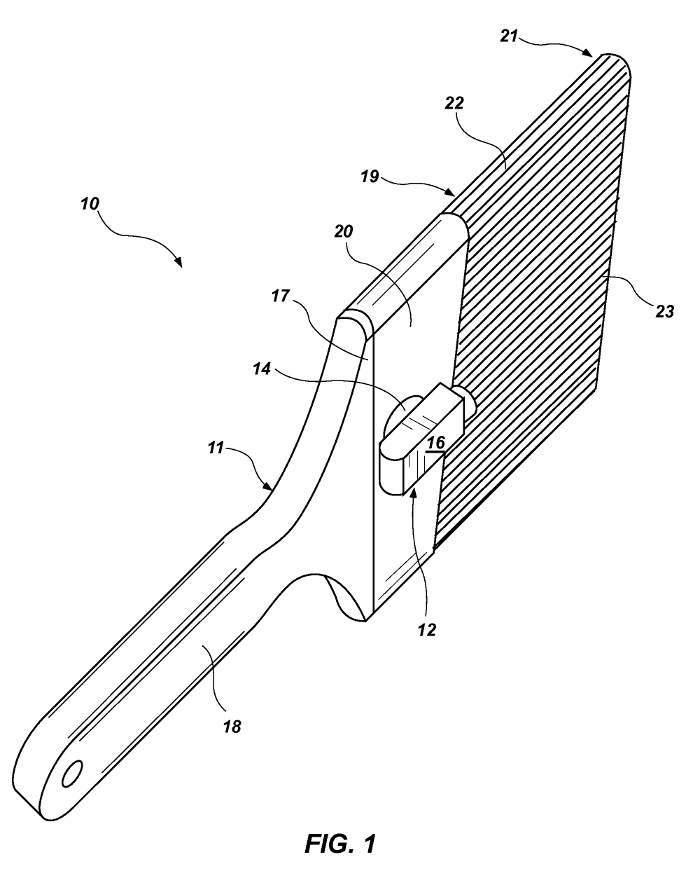

Referring to FIG. 1, while referring generally to FIGS. 1 through 4, an apparatus 10 in accordance with the invention may include a paintbrush 11 provided with a light assembly 12. In the illustrated embodiment, a paintbrush may be of any particular type, but is most applicable for the invention if it contains bristle or individual fibers. The light assembly 12 may be secured to the paintbrush 11 by any of several methods discussed hereinbelow.

The light assembly 12 may be comprised of a holder 14 or standoff 14. In reality, the assembly 14 may act as a securement 14 and as s standoff mechanism 14. For example, it has been found useful the light assembly 12 away from the paintbrush 11 a distance selected to optimize illumination at the tip of the working end of the brush 11.

It has been found that having the central axis of the beam of light emanating from the light assembly 12 nearby and parallel to an outer surface of the brush 11 illuminates the brush, but not the space being cut-in. That is, in the cutting-in operation, the brush is bent intentionally to thin the bristles down to a fine edge, and spread them out. Thus, the sweep or area of coverage of the light assembly 12 is most effective when it extends a distance beside the brush, thus capturing the exact line formed by the edge of the brush 11 during a cutting-in operation.

In the illustrated embodiment, the light assembly 12 includes a housing 16 secured by the holder 14 and positioned away from the standoff 14. Thus, the housing 16 may be thought of as the structural mechanics, while the holder 14 and standoff 14 may be integrated into a single element, such as a magnet secured to a brush 11 forward (toward the paint-containing, toe or application end) of the brush 11. Thus, a handle 18 may have a narrower portion for holding, and may extend toward a wider part 17 of the handle 18, which then engages the ferrule 20.

The ferrule 20 is effectively a band 20, typically of metal, and most typically of steel, capturing and securing the bristles 22 near the heel 19 of the brush 11. The region of bristles 22 just outside the ferrule 20 is referred to as the heel 19, and typically holds no quantity of paint. Good painting technique fills the toe portion with paint, always leaving the heel dry.

As a practical matter, bristles 22 may be synthetic or natural. Actual bristle is an animal product. However, many modern brushes are formed with thin filaments of nylon, polyester, or other appropriate polymeric materials.

Between the bristles 22 is maintained a quantity of paint by virtue of capillary action. Surface tension maintains the paint within the bristles 22. Surface tension between the paint on the work piece and paint in the toe 21 or the extreme distal end 21 of the bristles 22 tends to draw more paint out of the bristles 22 toward the handle 18, such as within the ferrule 20.

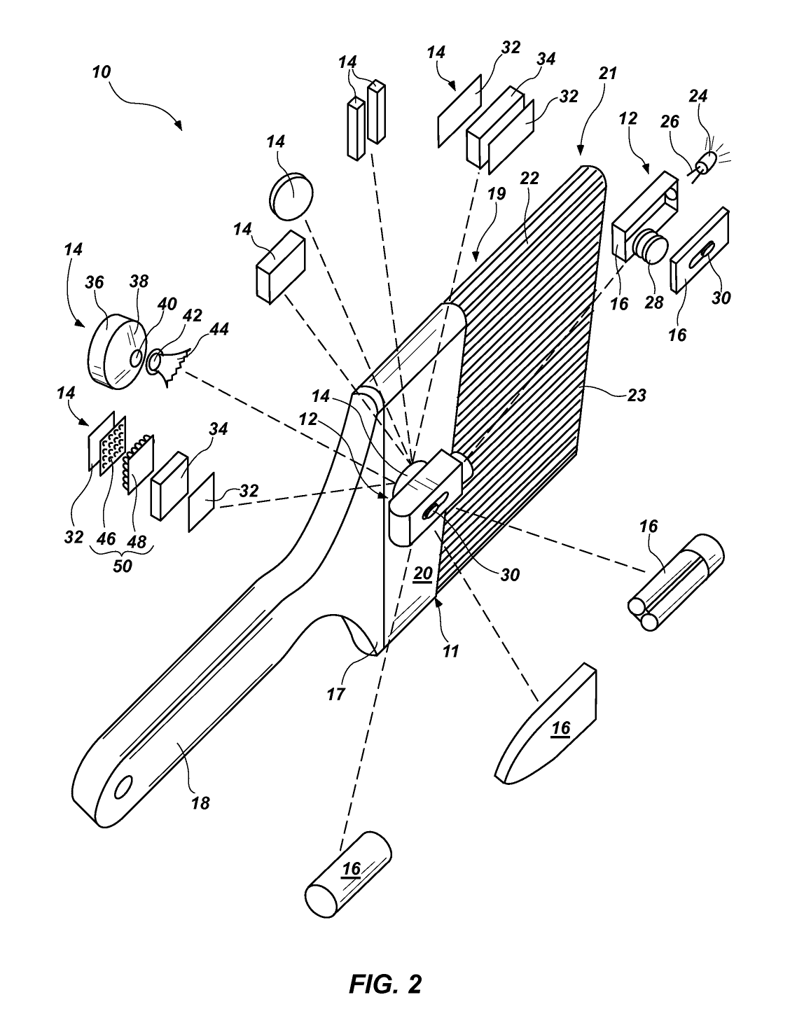

Referring to FIG. 2, while continuing to refer generally to FIGS. 1 through 4, a bulb 24 may be set in the housing 16 in order to illuminate an edge of the bristles 22. A variety of housing 16 types and standoff spacer 14 mechanisms may be implemented in various embodiments of the invention.

As a practical matter, the bristles 22 at the toe 21 are formed into a thin, sharp edge 23 by laying a flat aspect of the bristles 22 or the bundle of bristles 22 against the wall 54, and then pivoting the handle 18 around the heel 19 in order to spread the bristles 22 in two dimensions. That is, the bristles 22 closest to the wall are drawn back away from the edge 23 by bending the entire bundle, thus leaving fewer bristles 22 at the edge 23. Thus, by bending the bristles 22, the edge 23 is formed by the few bristles 22 that are closest to the line where paint will be cut-in. Meanwhile, the bristles 22 are accordingly distorted or deformed, being bent to one side.

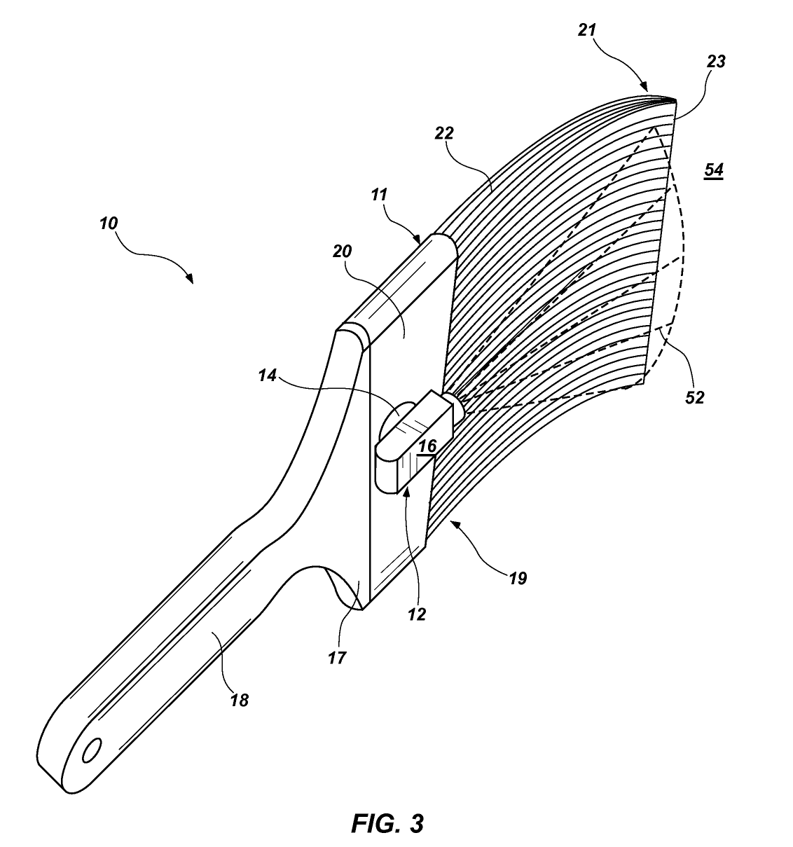

In FIG. 3, if the wall were on the left side of the brush 11, then the bristles 22 would be bent from the heel 19 to the right. Meanwhile, the bristles 22 along the edge 23 would also deflect or deform upward as the brush 11 is drawn downward.

The bulb 24 may be offset by the holder 14 or standoff 14 a distance away from the ferrule 20, typically by being attached by a magnet to the ferrule 20. Accordingly, the center line of the illumination by the bulb 24 will typically include the edge 23 of the bristles 22.

In the illustrated embodiment, various options are illustrated for the holder 14 and standoff spacer 14, the housing 16, and so forth. For example, the housing 16 may be made in a shape suitable for a type AA battery, a pair of type AAA batteries, a watch type or flat disc-like battery, or the like. Thus, the different shapes illustrated show how various types of batteries may be encased in housings 16 adapted thereto. The housing 16 will encompass both the batteries 28 and the bulb 24, it may be sized appropriate to the type of battery 28 being used.

Typically, the light 24 may be a light emitting diode (LED), or any suitable light source. As a practical matter, LED's require minimal energy for the available illumination and are a reasonable and efficient choice. However, various types of batteries 28 have wide ranging costs, sizes, current capacities, and so forth.

For example, larger batteries, single batteries, and the like may be preferable to the individual or stacked pancake (e.g., watch batteries) batteries illustrated. Likewise, the leads from the bulb 24 may pass through a switch 30 in order to turn the bulb 24 on and off. That is, power from the battery 28 is passed through an open circuit or to a closed circuit by the opening and closing of the switch 30.

In the illustrated embodiment, the securement mechanism 14, alternatively referred to as a holder 14 or a standoff 14 has several characteristics. Thus, it is a multi-functional device. In some embodiments, a magnet may be glued to the housing 16, and serve completely adequately. In other embodiments, permanent or temporary fastening mechanisms 14 may be used.

For example, in the illustrated embodiment, an adhesive layer 32 may be bonded to a spacer 34. Meanwhile, if these represent the entire mechanism 14 or securement mechanism 14, then only a limited number of attachments and detachments will be possible. By contrast, a magnet in a bar shape, disc shape, or rectangular block shape as illustrated may serve as the holder 14, by simply adhering to the ferrous material of which the ferrule 20 is made. Thus, a single, double-sided adhesive tape (e.g., plastic foam, double-stick tape) may secure such a magnet serving as a standoff spacer 14 to the housing 16, thus securing the light assembly 12.

In alternative embodiments, a snap socket 36 may have a face, which may be shaped flat, tapered, such as for piloting, or the like. The snap socket 36 may have an aperture 40 through the face 38. Typically, a ball 42 or other shape, such as a circular snap 42 or the like, may fit into the aperture 40 by an interference fit. The interference fit thus gives a grip holding the ball 42 or male snap portion 42 securely to the female socket portion 36.

The base 44 or trunnion 44 may be secured in any suitable way, such as gluing to a brush 11, fastening, threading, or any other suitable adhesive method. Typically, the surface area of the trunnion 44 may be considerably greater than that required for the snap ball 42 or the aperture 40. Thus, lower stress requirements will result. For example, a greater surface area provides that adhesion will persist even against greater forces due to the addition of distribution of stress at the adhesive boundary between the trunnion 44 and ferrule 20 or other portion of the handle 11.

In one embodiment, a hook material 46 may be selectively separable from a loop material 48 such as is available in the Velcro™ brand hook-and-loop fastener or similar product. Thus, the two materials 46, 48 combine to form a hook-and-loop fastener 50. By adhering one portion of the fastener 50 to the ferrule 20, the other portion thereof may be selectively separable at will. In the illustrated embodiment, an exploded view thereof illustrates how an adhesive layer 32 may bond a spacer 34 against the ferrule 20. Meanwhile, another adhesive layer 32 may be placed between the loop material 48 and the spacer 34. Alternatively, these may be glued together by an adhesive smeared on a surface of the spacer 34, the loop material 48, or both.

The hook material 46 that forms the other half of the fastener 50 may also be adhered by an adhesive layer 32 to the housing 16 of the light assembly 12. Meanwhile, the hook-and-loop fastener 50 may be selectively separable in order to remove, replace, service, aim, or otherwise manipulate the light assembly 12, its position, or components.

Referring to FIG. 3, while continuing to refer generally to FIGS. 1 through 4, in one embodiment of an apparatus 10 and method in accordance with the invention, a brush 11 may be used for cutting-in on a painted surface 54 by projecting light 52 onto that painted surface 54. In the illustrated embodiment, the bristles 22 are deflected toward the right, and upward as typical of a brush 11 being drawn downward, while feathering or edging, as required for cutting-in.

In this embodiment, the offset 14 is responsible to space the light assembly 12, and specifically to orient the housing 16 in order to both aim the light, and to secure the housing 16 to the ferrule 20. Again, the central axis of the beam of light 52 need not be coincident with the edge 23 of the bristles 22. In fact, so long as the circle of light 52 or other shape of light extends out (e.g., to the right side in the illustrated embodiment) of the edge 23, then a user can see and detect the position of the edge 23, and the color at the cut-in portion of the painted surface 54.

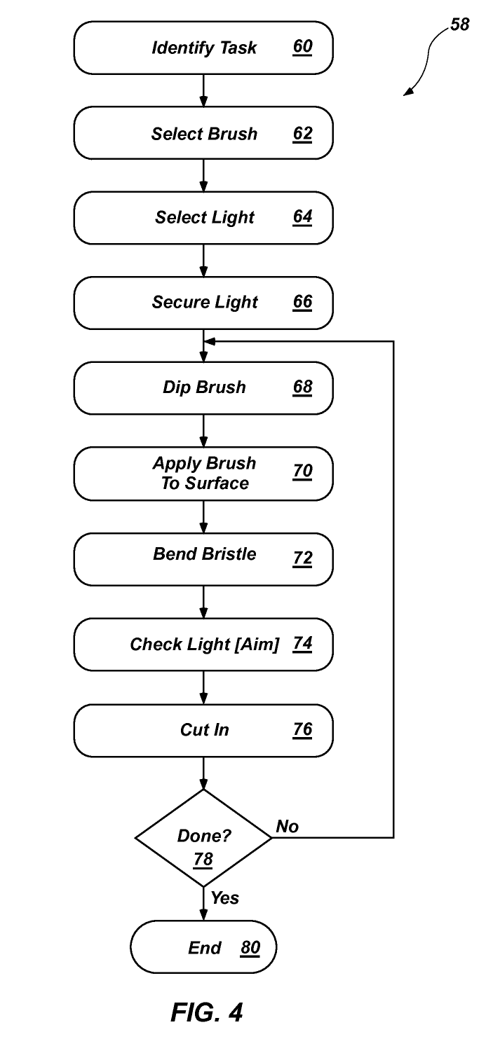

Referring to FIG. 4, in one embodiment of a method 58 in accordance with the invention, one may identify 60 the particular painting task to be undertaken. This will determine to a large extent the nature of a brush 11 that is selected 62. Likewise, the thickness or the effective standoff distance of a holder 14 or securement mechanism 14 will depend, or may depend upon the length, thickness, and so forth of the bundle of bristles 22 in the brush 11. Thus, one may select 64 a light assembly 12 of suitable size, intensity, like type, beam spread, and so forth.

In certain embodiments, the housing 16 may include lenses, focus materials, movable portions, or the like in order to better aim the light 52 emanating from the bulb 24. In other embodiments, the securement mechanism 14 operating as a standoff 14 may be general enough to capture the edge 23 of the bristles 22 in its projected light 52 within a sufficiently broad circle or other shape for virtually any cutting-in and distortions associated therewith.

Upon selecting 64 a particular light assembly 12, one may secure 66 the light assembly 12 by means of the holder 14 against a location on the ferrule 20 19 of the brush 11. Typically, that location will be on the ferrule 20. This is a convenience because the ferrule 20 is typically made of a high-stress metal, which will often be a ferrous metal. Thus, typically, a ferrule 20 may be magnetic metal, and will receive and hold a magnet 14 as the holder 14.

Securing 66 the light assembly 12 might be as simple as setting a magnet 14 of the light assembly 12 against the ferrule 20, where it will be held by magnetic attraction. In other embodiments, such as those illustrated hereinabove, securement 66 may be temporary, permanent, or a combination. Similarly, it may easily removable, removable with difficulty, positionable without removal, or the like.

For example, a ball 42 type of securement mechanism 14 may be rotated and pivoted if the face 38 is tapered to provide a range of motion. By contrast, a hook-and-loop type of fastener 50 will have to be removed and re-secured to change in any direction.

Once the light assembly 12 is in place and properly aiming 74 the light 52 (beam on the lighted region), one may dip 68 the bristles 22 into a source or supply of paint in order to load the bristles 22 by capillary action with paint. Now, the brush 11 is ready to apply 70 the paint to the working surface 54. As the application 70 of paint to the working surface 54 or painted surface 54 continues, the brush may or may not be positioned for cutting-in. At a time that cutting-in is required, the bending 72 of the bristles 22 will effectively form the edge 23 as described hereinabove. Thus, bending 72 may be thought of as forming 72 the edge 23 required for cutting-in.

At this point, one may choose to check 74 or adjust 74, aim 74, or otherwise correct 74 the light assembly 12. Typically, the bulb 24 may be positioned in fixed relation to the housing 16, thus requiring a movement of the entire light assembly 12 in order to provide aiming. By whichever means, one may adjust 74 by a combination of checking, removing, rotating, or otherwise aiming 74 the bulb 24 in order to create the proper region of light 52 illuminating the edge 23 of the bristles 22.

As cutting-in 76 proceeds, one may check, by the light of the bulb 24, to determine that the paint is sufficiently thorough, provides the coverage, opacity, and so forth required. Similarly, the edge 23 of the line of paint on the painted surface 54 may be deemed completed. Thus, once the test 78 determines that the cutting-in 76 has not been done, and a negative response to the test 78 returns the process to dipping 68, and further applying 70, and so forth. Nevertheless, a positive or affirmative response to the test 78 indicates that the cutting-in 76 is done. Accordingly, the cutting-in 76 comes to an end 80. Nevertheless, portions of the process 58 may continue as other portions are painted where cutting-in 76 is not required.

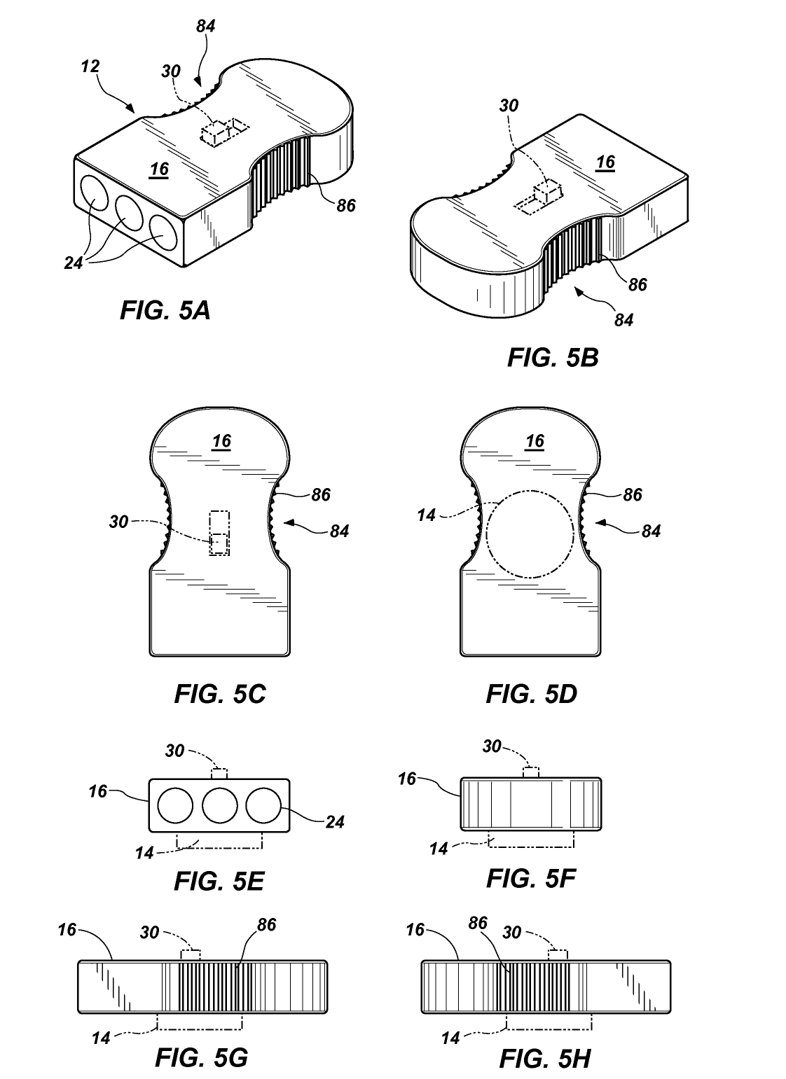

Referring to FIGS. 5A through 5D, in an alternative embodiment of a design for an apparatus 10 in accordance with the invention, a securement 14 may operate as a stand off 14 as described hereinabove. In this embodiment, the housing 16 has a different aspect ratio of width to height above the surface of the ferrule 20 of the brush 11. In this instance, the light 24 is replaced by three lights 24, such as LED (light emitting diode) bulbs 24, or the like.

In this embodiment, the switch 30 as well as the securement 14 are showed in broken lines. This is because those items have been discussed in detail with respect to FIGS. 1 through 3. Here, those elements are not necessary nor critical to all designs. For example, any suitable switch 30 may be substituted. Likewise, any suitable securement 14 discussed hereinabove may be suitable.

For example, with respect to the illustrations of FIG. 2, the several different embodiments of a housing 16 may be the approximately rectangular one that is illustrated in FIGS. 1 through 3. Alternatively, as illustrated in FIG. 2, and proceeding clockwise from the exploded view therein, one embodiment may simply be represented as a housing 16 shaped to hold two cylindrical batteries and a having a head containing the light 24. That configuration or embodiment looks the same from either side, and a switch, an opening, or the like may be added to the design.

Similarly, proceeding clockwise through the next design, which has something of a shield shape, such an apparatus may have a switch 30 and a securement 14 operating as a stand off 14 as described hereinabove, with a housing 16 shaped as illustrated. This embodiment looks the same from either side, and the front being a mirror image. In this embodiment, a row of LED's such as those illustrated in FIGS. 5A through 5H may be suitable. Likewise, this embodiment may be sufficiently thin that it serves best to use flat disc type batteries 28, rather than conventional cylindrical batteries 28, such as the common AAA batteries 28 readily available.

Likewise, moving clockwise to the last design of FIG. 2, a simple cylinder having suitable openings for receiving a light, as well as for replacing a battery through the same opening or one at an opposite end, may receive a securement 14 on one side thereof, and a switch 30 at any suitable location.

Referring to FIGS. 5A through 5H, the housing 16 may have an indentation 84, which may include knurling, ribbing, or another treatment to improve grip. Thus, if a hand is wet, gloved, or otherwise inhibited from providing direct contact or firm contact between the housing 16 and the hand of a user, the indent 84 and its associated grip feature or texture 86 may assist in maintaining a firm grip on the apparatus 10.

One will note that the lights 24 are multiple in this, providing a comparatively low profile minimizing the moment (as the word is used in engineering parlance) or leverage. For example, if the apparatus 10 is bumped, then the lower profile tends to provide less leverage of such a touching of the housing 16 against the grip of the securement 14 fastened to the ferrule 20 or adhered to the ferrule 20. Thus, the apparatus 10 will be more stable in use. Likewise, by having a lower profile, the dynamics of motion and force inherent in movement of a brush 11 equipped with the light assembly 12 will minimize the disruption or movement of the light assembly 12, thus minimizing readjustments.

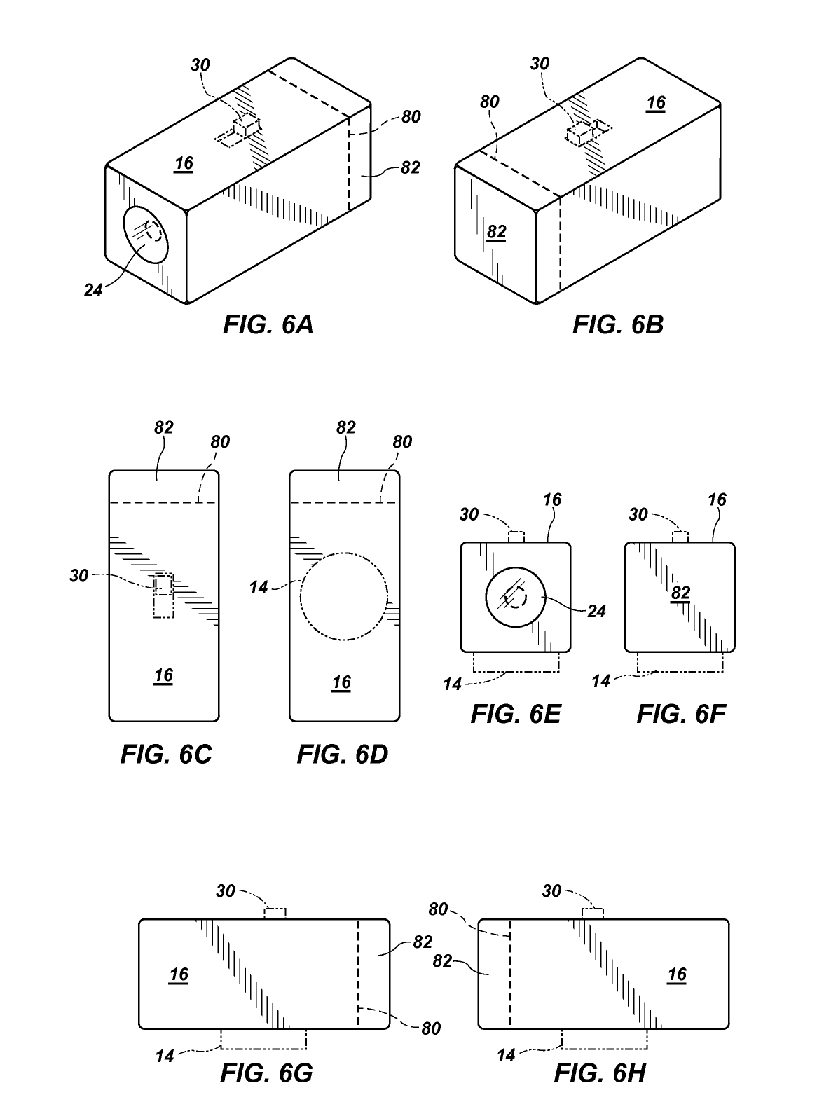

Referring to FIGS. 6A through 6H, an approximately rectangular embodiment of a light assembly 12 includes a separation 80 or parting line 80 that may be positioned at any suitable location, and in any suitable shape for changing out batteries 28 installed therein. In the illustrated embodiment, the bulb 24 is illustrated as a single bulb 24, but may be replaced by multiple bulbs 24, such as an array of LED's, or the like. In the illustrated embodiment, the light 24 is illustrated as represented by a single circle which may be appropriate for such a geometry. Here likewise, the switch 30 and securement 14 are not central to the overall design of the housing 16. Rather, any suitable switch 30, at any suitable mechanism or geometry for a securement 14 acting as a stand off 14 may be used, as described hereinabove.

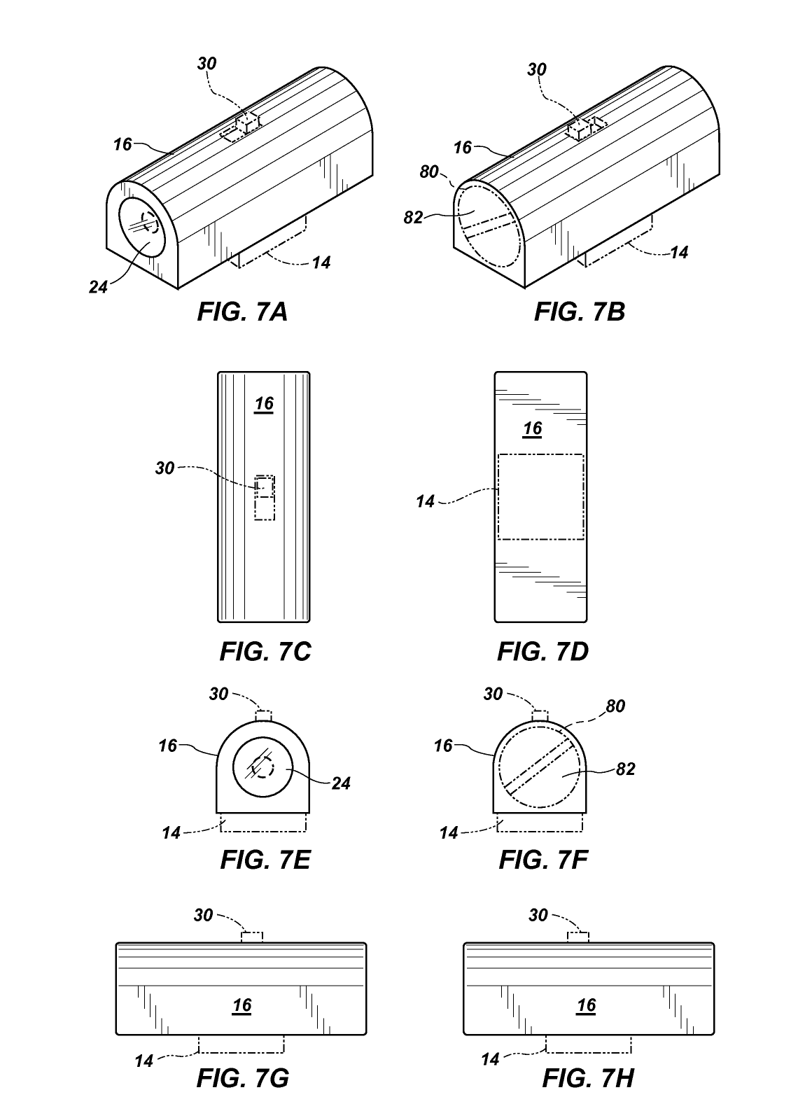

Referring to FIGS. 7A through 7H, one embodiment of a light assembly 12 may rely on a shape that has few corners or edges. It is similarly spaced away from the ferrule 20 on which the light assembly 12 is mounted by the securement 14. In this illustration, a single securement 14 is illustrated to operate as a stand off 14. Nevertheless, multiple magnets 14, clips 14, or the like may be used, as described hereinabove.

One advantage to the design of FIGS. 7A through 7H is that the effect (e.g., dislodging, moving) of bumping or sliding against clothing or work pieces, touching by a hand, and the like will be minimized, resisting loss or misalignment of the light 24 and its associated beam 52. Thus, it may be an advantage to provide a comparatively lower profile with respect to the surface of the ferrule 20 to which the light assembly 12 attaches. Likewise, a comparatively larger base area secured to the ferrule 20 may also provide for additional resistance to tipping (leverage, bearing length) with respect to the ferrule, and improved strength of grip of the securement 14.

Of course, a certain distance is required for the stand off 14 or securement 14 in order to position the light element 24 at a height that will illuminate (by the beam 52) the edge 23 of the bristles 22 as described hereinabove. Thus, the configurations of FIGS. 5A through 5H and 7A through 7H provide comparatively lower profiles of the housing 16 itself, with minimum elevation above the surface of the ferrule 20. It should be noted that the views of FIG. 2, of alternative housings 16 are the same on the sides not viewable in the illustration. Similarly, any of the securements 14 or stand offs 14 of FIG. 2 may be applied in a suitable adaptation to any of the designs of FIGS. 5A through 7H inclusive.

The present invention may be embodied in other specific forms without departing from its purposes, functions, structures, or operational characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. A method comprising;
providing a brush;
providing a lighting assembly;
providing a securement mechanism;
providing a standoff mechanism;
securing the lighting assembly to the brush at a position maintained by the securement mechanism and spaced from the brush by the standoff mechanism;
deflecting the bristles of the brush to form an edge suitable for cutting-in a paint line; and
illuminating operation of the edge by light from the light source.

2. The method of claim 1, wherein:
the securement mechanism is selected from a magnet, an adhesive, a snap, and a hook-and-loop fastener; and
the standoff mechanism is selected from the bulk length of the magnet, a spacer coated on two opposite faces with the adhesive, a leg establishing a dimension of the snap, and a spacer secured to at least one of a hook element and a loop element of the hook-and-loop fastener.

3. The method of claim 2, further comprising aiming the light source by:
moving the light source with respect to the brush; and
re-securing the light source to the brush by the securement mechanism.

4. The method of claim 3 further comprising aiming the light at the edge by a combination of rotating the light source with respect to the handle of the brush, and selecting the standoff distance of the light from the brush.

5. The method of claim 1, further comprising aiming the light source with respect to two dimensions of the brush.

6. The method of claim 1, further comprising:
moving the light source on the brush from a first location thereon; and
fixing the light source to the brush, at a second location thereon, by the securement mechanism.

7. The method of claim 1, further comprising:
aiming the light at a portion of the edge by a user, based on the personal preference of the user.

8. The method of claim 7, wherein aiming is effected by at least one of:
rotating the light source with respect to the handle of the brush;
translating the light source with respect to the handle of the brush; and
selecting a standoff distance of the light away from the brush.

9. The method of claim 1, further comprising:
selecting environmental lighting illuminating a work piece to be painted;
placing at least one of a user, the brush, and another obstruction between the environmental lighting and the bristles on the work piece during painting; and
providing, from the light source, auxiliary light on the bristles and work piece in addition to an available portion of the environmental lighting thereat.

10. The method of claim 1, wherein:
the brush further comprises a ferrule formed of a ferrous metal; and
the method further comprises securing the light source to the ferrule by magnetic force.

11. A process for cutting-in a paint line with localized illumination, the method comprising:
selecting a brush having a handle and bristles;
securing a light to move in rigid body motion with a brush;
dipping the brush to receive paint;
forming an edge by bending the bristles of the brush against the surface to be painted;
applying paint to a surface by contacting the surface with at least the edge; and
applying paint to the surface.

12. The method of claim 11 further comprising re-aiming the light after the applying the paint to the surface.

13. The method of claim 12, wherein re-aiming further comprises:
releasing a securement mechanism;
re-aligning a beam from the light; and
re-securing the light by the securement mechanism.

14. The method of claim 13, wherein:
the securement mechanism is selected from a magnet, an adhesive, a snap, and a hook-and-loop fastener; and
the standoff mechanism is selected from the bulk length of the magnet, a spacer coated on two opposite faces with the adhesive, a leg establishing a dimension of the snap, and a spacer secured to at least one of a hook element and a loop element of the hook-and-loop fastener.

15. The method of claim 3, further comprising:
aiming the light at the edge by at least one of rotating the light source with respect to the handle of the brush, and selecting the standoff distance of the light from the brush;
the aiming, further comprising directing, by a user and based on personal preference of the user, the light to illuminate at least a portion of the edge.

16. The method of claim 11, further comprising:
selecting environmental lighting illuminating a work piece to be painted;
placing at least one of a user, the brush, and another obstruction between the environmental lighting and the bristles on the work piece during painting; and
providing, from the light source, auxiliary light on the bristles and work piece in addition to an available portion of the environmental lighting thereat.

17. An apparatus comprising;
a brush suitable for holding paint and depositing the paint on a surface to be painted;
a lighting assembly securable to the brush and aimable at an edge of the bristles of the brush in order to effectively illuminate the edge;
a securement mechanism securing the light assembly to the brush; and
a standoff mechanism spacing the lighting assembly away from the brush a distance selected to illuminate the edge of the bristles of the brush when the bristles are deflected to form an edge suitable for cutting-in along a line.

18. The apparatus of claim 17, further comprising:
a handle;
the bristles, positioned to extend away from the handle;
a ferrule attached to secure the bristles to the handle; and
the standoff mechanism, further comprising material sized as a spacing structure spacing the light assembly away from the ferrule.

19. The apparatus of claim 18, further comprising:
the bristles, formed to deflect laterally in response to a force;
the brush, positioned proximate a work piece illuminated by environmental light spaced away from the workpiece;
the securement mechanism, further selected from a magnet, an adhesive, and a mechanical fastener;
the standoff mechanism, further selected from a length of a magnet, a solid material; a foam material, a stacked assembly of a plurality of materials;
the securement mechanism, further being selectively removable and attachable directly to the brush by hand without tools; and
the lighting assembly being sized and positioned in fixed relation to the brush to be substantially continually closer to the bristles, during painting, than an environmental source of the environmental lighting.

20. The apparatus of claim 17, further comprising:
the light source further including a power source as the exclusive source of power for the lighting source and integrated into a housing with a lighting element discharging visible light;
an access opening in the housing for replacing the power source; and
the housing sized to be manually removable and positionable on the brush.
